(19) United States
(12) Patent Application Publication
(10) Pub. No.: US 2006/0008744 A1
(43) Pub. Date: Jan. 12, 2006

(54) Device and method for curing sealant of liquid crystal display panel

(75) Inventors: Wei Lun Hsiao, Miao-Li (TW); Ting Hau Chang, Miao-Li (TW); Yen Chung Chang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/179,081

(22) Filed: Jul. 11, 2005

(30) Foreign Application Priority Data
Jul. 9, 2004 (TW) 93120643

(51) Int. Cl. G02F 1/1339

(52) U.S. Cl. 430/321; 250/493.1

(57) ABSTRACT

A sealant curing device (9), for a liquid crystal display panel (2) having a black matrix (300), sealant (700), and liquid crystal (500). The sealant curing device includes a worktable (800) having a reflecting surface (801) which reflects ultraviolet light to the sealant so as to cure it, and a plurality of supporting members (600) disposed on the worktable to support the liquid crystal display panel. The ultraviolet light is reflected by the reflecting surface to irradiate portions of the sealant shielded by the black matrix. Heights of the supporting members can be adjusted to change the angles of incidence of the ultraviolet light, thereby helping ensure that the sealant is completely cured. A side reflector (150) is also provided. In this way, the entire sealant can be completely cured, and the liquid crystal cannot be contaminated by uncured sealant. This can improve the display quality and efficiency of manufacture.

### FIELD OF THE INVENTION

The present invention generally relates to a sealant curing device used in the manufacture of LCD (liquid crystal display) panels, and a related method for curing a sealant.

### GENERAL BACKGROUND

An LCD panel generally comprises two glass substrates, a peripheral sealant, and a multiplicity of liquid crystal molecules. The sealant is used for adhering the glass substrates together and thus forming a space therebetween. The liquid crystal molecules are filled in the space.

As shown in FIG. 4, a conventional liquid crystal display panel 1 includes a first substrate 10, a sealant 70, liquid crystal 50, and a second substrate 20. A plurality of photoresists 40 and a black matrix 30 are arranged on an inner surface of the first substrate 10.

During a processing for fabricating the liquid crystal display panel 1, the sealant 70 is coated on the second substrate 20, the liquid crystal 50 is dropped onto the second substrate 20, and the first and second substrates 10, 20 are pressed together. Then a process of curing the sealant 70 is performed, to secure the first and second substrates 10, 20 to each other.

Referring to FIG. 5, the liquid crystal display panel 1 is arranged on a worktable 80. Ultraviolet light of an ultraviolet light source is applied to irradiate the sealant 70 so as to cure the sealant 70. However, a region A of the sealant 70 is blocked by the black matrix 30. Thus, the sealant 70 cannot be completely cured. The liquid crystal 50 may be contaminated by the uncured sealant 70, thereby adversely affecting the display quality of the liquid crystal display panel 1.

Further, even if the ultraviolet light is applied incident from an underside of the second substrate 20, circuits arranged on the second substrate 20 may also block the ultraviolet light from reaching portions of the sealant 70.

What is needed, therefore, is a device and a method for curing sealant that overcomes the above-described deficiencies.

### SUMMARY

In a preferred embodiment, a sealant curing device, for a liquid crystal display panel having a black matrix, sealant, and liquid crystal. The sealant curing device includes a worktable having a reflecting surface which reflects ultraviolet light to the sealant so as to cure it, and a plurality of supporting members disposed on the worktable to support the liquid crystal display panel. The ultraviolet light is reflected by the reflecting surface to irradiate portions of the sealant shielded by the black matrix.

In another preferred embodiment, a method for curing sealant includes the steps of: providing a worktable having a reflector and a plurality of supporting members; arranging a liquid crystal display panel with a black matrix on the supporting members; curing the sealant by directly irradiating ultraviolet to the sealant which is not overlapped by the black matrix; and completely curing the sealant by reflecting ultraviolet at the reflector to irradiate to the sealant that is overlapped by the black matrix.

The ultraviolet light may be reflected by the reflector to irradiate the sealant covered by the black matrix. Heights of the supporting members can be adjusted to change the angles of incidence of the ultraviolet light, thereby helping ensure that the sealant is completely cured. A side reflector is also provided. In this way, the entire sealant can be completely cured, and the liquid crystal cannot be contaminated by uncured sealant. This can improve the display quality and efficiency of manufacture.

Other advantages and novel features of preferred embodiments will become more apparent from the following detailed description when taken in conjunction with the accompanying drawings, in which:

### BRIEF DESCRIPTION OF THE DRAWINGS

FIG. 1 is a simplified, schematic, side cross-sectional view of part of a sealant curing device according to a first embodiment of the present invention, together with one substrate of a liquid crystal display panel mounted on the sealant curing device;

FIG. 2 is similar to FIG. 1, but showing the entire sealant curing device according to the first embodiment together with the entire liquid crystal display panel mounted on the sealant curing device, and showing one stage in a method for curing a sealant of the liquid crystal display panel according to an exemplary embodiment of the present invention;

FIG. 3 is similar to FIG. 2, but showing a different liquid crystal display panel having a different configuration of sealant;

FIG. 4 is a simplified, schematic, side cross-sectional view of a conventional liquid crystal display panel; and

FIG. 5 is a schematic, side cross-sectional view showing one stage in a method for curing a sealant of the liquid crystal display panel of FIG. 4 using a conventional sealant curing device.

### DETAILED DESCRIPTION OF PREFERRED EMBODIMENTS

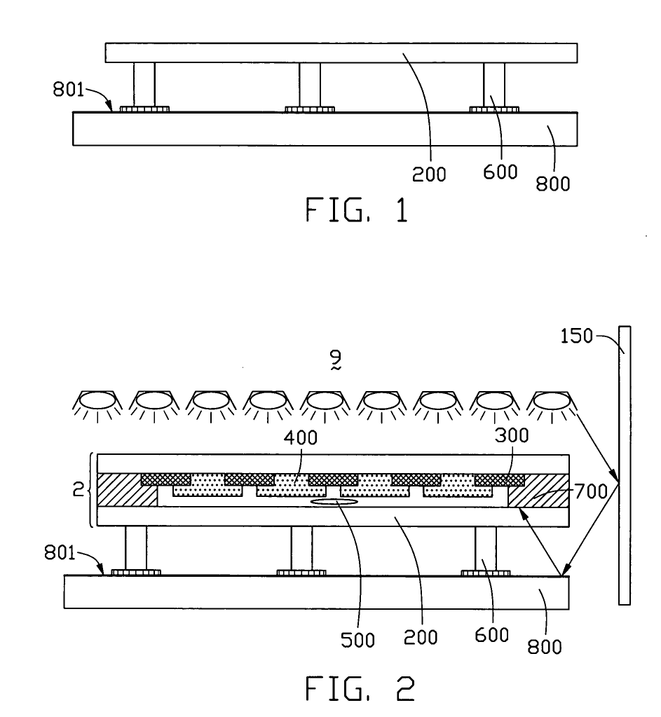

FIG. 1 shows a cross-sectional view of part of a sealant curing device 9 according to a preferred embodiment of the present invention, together with one substrate 200 (of a liquid crystal display panel 2) mounted on the sealant curing device 9. FIG. 2 is similar to FIG. 1, but shows the entire sealant curing device 9 together with the entire liquid crystal display panel 2 mounted on the sealant curing device 9. The sealant curing device 9 includes a worktable 800, a reflecting surface 801 formed on the worktable 800, and a plurality of supporting members 600 arranged on the worktable 800. Referring also to FIG. 2, the supporting members 600 can cooperatively support the liquid crystal display panel 2. A height of each supporting member 600 is adjustable. The reflecting surface 801 has a high reflectance.

As shown in FIG. 2, a preferred method for curing a sealant 700 of the liquid crystal display panel 2 includes the steps of: placing the liquid crystal display panel 2 on the supporting members 600 of the worktable 800; and applying ultraviolet light to irradiate the sealant 700 so as to cure the sealant 700. In the illustrated embodiment, a radiant intensity of the ultraviolet light is preferably in the range from 20000 to 40000 J/m².

When directly applying the ultraviolet light to irradiate the sealant 700, parts of the sealant 700 are irradiated via a color filter 400 of the liquid crystal display panel 2. However, other parts of the sealant 700 are shielded by a black matrix 300 of the liquid crystal display panel 2, and such parts of the sealant 700 cannot be completely cured by the ultraviolet light. Accordingly, a reflector 150 is disposed at a side of the worktable 800. Respective portions of the ultraviolet light are incident on the reflector 150 and on the reflecting surface 801, and are reflected by the reflector 150 and the reflecting surface 801. The reflected ultraviolet light is then incident on the sealant 700, including the parts of the sealant 70 that are shielded by the black matrix 300. Further, other portions of the ultraviolet light directly irradiate the parts of the sealant 700 that are not shielded by the black matrix 300. Thus overall, the entire sealant 700 is completely cured.

The heights of the supporting members 600 can be adjusted so as to correspondingly adjust incident angles of the ultraviolet light and thereby ensure that the sealant can be completely irradiated and cured. Further, the reflector 150 may be flat or concave. Accordingly, the sealant 700 can be cured completely, and contamination of liquid crystal 500 of the liquid crystal display panel 2 by the sealant 700 can be avoided. This in turn improves the efficiency of mass production of the liquid crystal display panel 2.

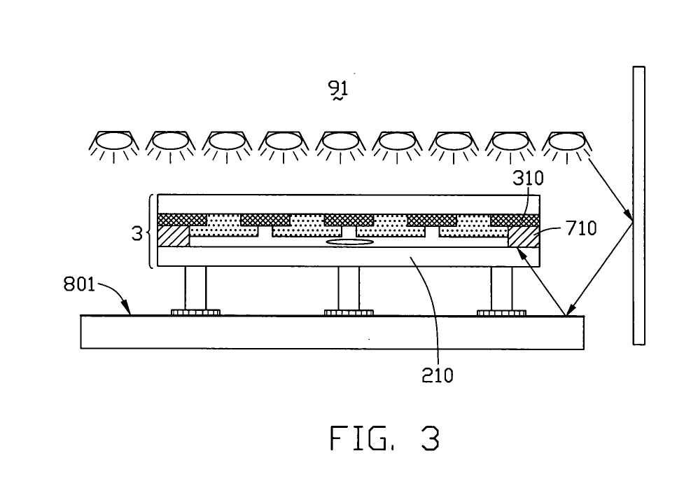

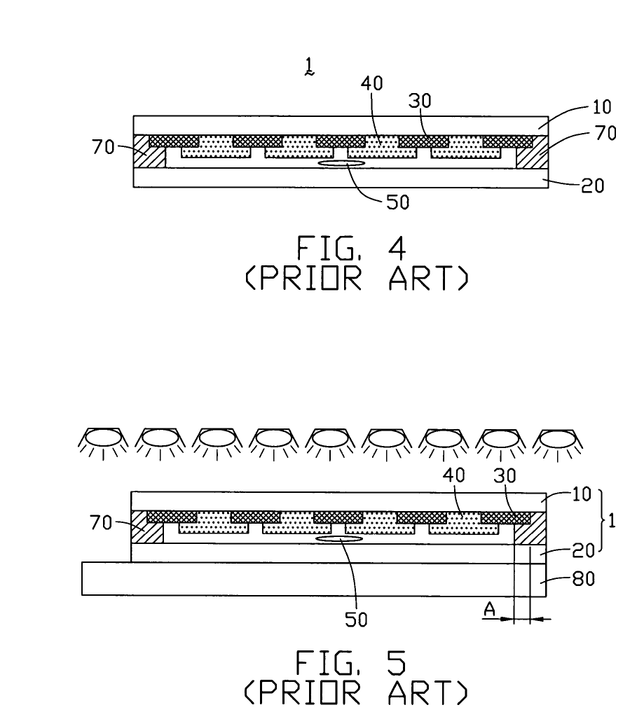

FIG. 3 is similar to FIG. 2, but showing a different liquid crystal display panel 3 having a different configuration of sealant 710. The sealant 710 is located on a bottom substrate 210 of the liquid crystal display panel 3, and does not contact a top substrate of the liquid crystal display panel 3. Parts of the sealant 710 are shielded by a black matrix 310 of the liquid crystal display panel 3. The sealant 710 can still be completely cured, with the aid of ultraviolet light reflected by the reflecting surface 801 of the worktable 800 and ultraviolet light reflected by the reflector 150 disposed at a side of the liquid crystal display panel 3.

It is to be understood, however, that even though numerous characteristics and advantages of the embodiments have been set out in the foregoing description, together with details of the functions of the embodiments, the disclosure is illustrative only, and changes may be made in detail to the full extent indicated by the broad general meaning of the terms in which the appended claims are expressed.

What is claimed is:

1. A sealant curing device for curing a sealant of a liquid crystal display panel, the sealant curing device comprising:
a worktable having a reflecting surface for reflecting ultraviolet light to be incident on the sealant;
a light source disposed over the worktable for providing ultraviolet light to be incident on the sealant; and
one or more supporting members disposed on the worktable to support the liquid crystal display panel.

2. The sealant curing device as claimed in claim 1, wherein heights of the supporting members are adjustable.

3. The sealant curing device as claimed in claim 1, further comprising a reflector disposed at a side of the worktable.

4. A method for curing a sealant of a liquid crystal display panel, the liquid crystal display panel having a black matrix, the method comprising the steps of:
providing a worktable comprising a reflecting surface and one or more supporting members;
placing the liquid crystal display panel on the supporting members; and
curing portions of the sealant not shielded by the black matrix, by directly applying ultraviolet light; and simultaneously curing portions of the sealant shielded by the black matrix, by indirectly applying ultraviolet light via the reflecting surface.

5. The method as claimed in claim 4, wherein a reflector is disposed at a side of the liquid crystal display panel, and portions of the sealant shielded by the black matrix are cured by indirectly applying ultraviolet light via the reflector.

6. The method as claimed in claim 4, wherein heights of the supporting members are adjustable.

7. The method as claimed in claim 4, wherein a radiant intensity of the ultraviolet light is in the range from 20000-40000 J/m².

8. A method for curing a sealant of a liquid crystal display panel, the liquid crystal display panel having a black matrix, the method comprising the steps of:
providing a worktable;
placing the liquid crystal display panel above the worktable, said liquid crystal display panel defining opposite top and bottom faces wherein said bottom face facing the worktable; and
curing portions of the sealant not upwardly covered by the black matrix, by applying ultraviolet light from the top face; and simultaneously curing portions of the sealant upwardly covered by the black matrix, by applying ultraviolet light from the bottom face.

9. The method as claimed in claim 8, wherein the light from the bottom face comes from a reflective surface of the worktable.

10. The method as claimed in claim 9, wherein a distance is formed between the reflective surface of the worktable and the bottom face of the panel.

11. The method as claimed in claim 10, wherein at least one support member is sandwiched between the reflective surface and the bottom face.

12. The method as claimed in claim 8, wherein said light from the bottom face shares a same light source with the light from the top face.

13. The method as claimed in claim 12, wherein a reflector is located beside the panel and the worktable.
